(19) United States
(12) Patent Application Publication
(10) Pub. No.: US 2019/0020642 A1
(43) Pub. Date: Jan. 17, 2019

(54) METHOD AND DEVICE FOR CONNECTING TO A REMOTE SERVER

(71) Applicant: ORANGE, Paris (FR)

(72) Inventor: Chidung Lac, Ploulec'h (FR)

(21) Appl. No.: 16/065,995

(22) PCT Filed: Dec. 16, 2016
(86) PCT No.: PCT/FR2016/053500

§ 371 Date: Jun. 25, 2018

(30) Foreign Application Priority Data
Dec. 24, 2015 (FR) 1563291

(51) Int. Cl. H04L 29/06; G06F 21/31

(52) U.S. Cl. CPC H04L 63/083; G06F 2221/2117; G06F 21/31; H04L 63/0853

(57) ABSTRACT

A method includes a preliminary step during which, on a user accessing a remote server using a connection device, the user registers in the connection device, in association with an identifier of the remote server, the result of applying a function to authentication data of the user. On subsequent access by the user to the server using the connection device, the following steps are performed: a) the user inputs authentication data, which includes at least a password; b) the connection device compares the result of the function applied to the authentication data input during step a) with the results stored during the preliminary step; and c): in the event of a match, the connection device sends the user's identifier and password to the remote server; and in the event of a mismatch, the connection device sends a message to the user asking the user to verify the authentication data.

### CROSS-REFERENCE TO RELATED APPLICATIONS

This Application is a Section 371 National Stage Application of International Application No. PCT/FR2016/053500, filed Dec. 16, 2016, the content of which is incorporated herein by reference in its entirety, and published as WO 2017/109352 on Jun. 29, 2017, not in English.

### FIELD OF THE DISCLOSURE

The present invention relates to the digital communications.

More particularly, the present invention relates to protecting confidential data of users of a digital communications network, such as the Internet.

### BACKGROUND OF THE DISCLOSURE

The digital world in which we are immersed in everyday life requires people to identify themselves with a large number of services, covering both professional and personal activities, such as access to a social network, processing email, performing administrative procedures, managing bank accounts, or on-line purchasing of goods. The first step in accessing any digital service is to authenticate the user, regardless of whether the service is free (e.g. a social network) or paid-for (e.g. on-line purchase). This authentication usually consists in the user supplying an identifier and a password. It should be observed that other forms of authentication do exist (some operational others experimental), e.g. based on fingerprints, on the shape of the hand, on dynamic recognition of a signature or of typing on the keyboard, recognition of a face, or a retina, or a voice, or a heart rhythm. The present invention nevertheless relates only to the identifier-and-password pair, which is at present the authentication means that is the most widespread, and will remain so for a long time.

It is important for such identifier and password information to remain confidential in order to prevent a third party usurping the identity of the legitimate user; specifically, such usurpation may have grave consequences for the legitimate user, in particular financially speaking (e.g. consuming a service, or accessing a bank account).

The term “phishing” is used to designate the criminal activity performed in a digital network whereby a hacker seeks fraudulently to acquire private information such as the identifiers, the passwords, or credit card details from a certain user of a computer system. The term “phishing” refers to the use of electronic bait for “fishing” for a user's private data from an Internet site or in an email. The hacker usually seeks to be passed off for a person, an entity, or an activity that is known to the user and seeks to persuade the user to communicate private data. Phishing is an increasing problem in computer services, and means exist in the state of the art for the purpose of protecting users. Nevertheless, those means are of limited effectiveness insofar as it is very difficult for a user to distinguish between a legitimate correspondent and an illegitimate correspondent, e.g. between a legitimate web (worldwide web) page and an illegitimate web page.

In order to remedy that problem, patent application US 2012/0272330 discloses an anti-phishing system that is used when the user of a computer seeks to communicate with a remote server. The anti-phishing system then searches for the electronic address of the remote server in a “white” list of electronic addresses that are trustworthy. Thereafter:
if the electronic address of the remote server is in the white list, the computer transmits the identifier-and-password pair of the user to the remote server; and
in contrast, if the electronic address of the remote server is not in the white list, prior to transmitting the identifier and the password to the remote server, the computer performs some protective action, such as interrupting transmission of the identifier-and-password pair to the remote server, and/or displaying a message in order to warn the user that the remote server is not (or not yet) deemed to be trustworthy.

In an embodiment, the identifier-and-password pair is thus input by the user and the user's web browser sends that authentication data to the remote server when it appears in said white list, i.e. when it is deemed to be trustworthy. Under such circumstances, no verification is performed by the anti-phishing system as to the pertinence of the authentication data.

However, the author of the present invention has realized that the authentication data might not correspond to the user's true identifier-and-password pair for that remote server. As a result, the identifier-and-password pair may lose its confidentiality if the user discloses the identifier or the password or both together accidentally.

By way of explanation, it should firstly be recalled that an elementary rule of prudence for a user of a plurality of services consists in not using the same identifier-and-password pair for two different services. However such a rule has the drawback that it is difficult for a user to remember, or even to list, all of that user's service-identifier-password triplets. It can thus easily happen that a user inputs an erroneous identifier-and-password pair.

By way of example, consider a user who, in order to simplify the task, makes use of the same identifier (e.g. an email address) with different passwords for accessing different services. Now assume that the user, seeking to be authenticated with the server associated with a social network, sends the following information to that server:
a correct identifier; and
a password that enables the same user to be authenticated with the server associated with a bank with which the user possesses an account.

Under such circumstances, the password is thus erroneous, however the user will only become aware of the error after receiving in response from the server a message of the type “erroneous password!”. The danger of this situation is that the manager of the social network then knows, on the basis of the erroneous password, the user's correct identifier-and-password pair for banking services; if that manager is dishonest, or if a hacker gains access to the data stored in the server of the social network, then the manager or the hacker needs only to search for the servers (other than the server of the social network) that the user usually accesses, in order subsequently to be able to usurp the identifier of that user with the user's bank. Unfortunately, this type of error occurs commonly.

Naturally, the same risk of loss of confidentiality exists for a user who uses a different identifier for each service, in the event of that user sending to one service provider an identifier-and-password pair that corresponds in fact to another service.

### SUMMARY

The present invention thus relates to a connection method for connecting to a remote server, comprising a preliminary step during which, on a user accessing said remote server by means of a connection device, said user registers in said connection device, in association with an identifier of the remote server, the result of applying a certain function to authentication data of the user with the remote server. Said method further comprises, on subsequent access of the user to the remote server by means of the connection device, the following steps:
a) the user inputting authentication data for authenticating the user with the remote server, said authentication data comprising at least a password;
b) the connection device comparing the result of said function applied to said authentication data input during said step a) with said result stored during said preliminary step; and
c1) in the event of a match, the connection device sending the user's identifier and password to the remote server; and
c2) in the event of a mismatch, the connection device sending a message to the user asking the user to verify that the authentication data input during step a) is indeed the data the user wishes to send to the remote server, and proposing an interface to the user in order to enable the user to reply.

Thus, the present invention proposes warning a user who has input incorrect authentication data in order to be able to connect to a remote server (to which the user has already previously been connected), which data may be incorrect because of inattention or because of confusion with authentication data associated with some other remote server.

By means of these provisions, the user is given the possibility of correcting the error before sending authentication data to the remote server.

It should be observed that the present invention is not in any way incompatible with using a white list of the type used by the method according to application US 2012/0272330 as described briefly above.

It should also be observed that, advantageously, the invention requires the user to input authentication data each time the user wishes to access the remote server. Specifically, in a conventional technique (as also used by the method according to application US 2012/0272330 in an embodiment other than the embodiment described above), the identifier-and-password pair is initially registered in a dedicated memory in association with an identifier of the remote server; when the user seeks once more to communicate with that remote server, the identifier-and-password pair is merely supplied by or finished off by the computer. That conventional method has the drawback that any person forming part of the (home or professional) environment of the legitimate user of the service, and capable of using the user's computer, can access the remote server without even knowing the password (which as a general rule is also not displayed on the screen associated with the computer). Unfortunately, certain people capable of using the computer (e.g. the children of the legitimate user of the service) might not have the right to access that remote server.

According to particular characteristics, if, after receiving said message, the user realizes that said authentication data input during said step a) is erroneous, said method further comprises the following steps:
d) said user using said interface to indicate the desire to correct the input, and the user inputting new authentication data for authenticating the user with the remote server, said new authentication data comprising at least a password;
e) comparing the result of said function applied to said new authentication data with said result stored during said preliminary step; and
f) in the event of a match, sending the user's identifier and password to the remote server.

By means of these provisions, the user can, where appropriate, correct an input error quickly, and then connect to the remote server.

According to other particular characteristics, if, after receiving said message, the user realizes that said result stored during a said preliminary step is obsolete, said method further comprises the following steps:
d′) said user using said interface to indicate the desire to update the user's authentication data;
e′) registering the result of applying said function to said authentication data input by the user during said step a), in association with an identifier of the remote server; and
f′) sending the user's identifier and password to the remote server.

By means of these provisions, the user can quickly update the registration associated with the user's authentication data, and connect to the remote server.

According to yet other particular characteristics, after receiving said message, said method further comprises the following steps:
d″) said user using said interface to indicate that the user is a new user;
e″) registering the result of applying said function to said authentication data input by the new user during said step a), in association with an identifier of the remote server; and
f″) sending the new user's identifier and password to the remote server.

By means of these provisions, a single connection device can perform the invention for a plurality of users (each having their own identifier-and-password pair).

According to yet other particular characteristics, the result of said function comprises at least a portion of said password of the user for said remote server, in the clear or in encrypted form.

The variant consisting in encrypting the user's authentication data makes it possible to avoid registering the authentication data in the clear in the memory that is dedicated to registration according to the invention. This makes it possible to provide better protection for the authentication data (which is of very confidential nature as recalled above) that is associated with various remote servers to which the user commonly connects. Specifically, when the data is registered in the clear in said memory, a third party capable of using the computer of the legitimate user, or a hacker managing to gain access to that memory, would thereby gain access to all of the authentication data, which would clearly have very harmful consequences for the legitimate user.

Correspondingly, the invention also provides a connection device for connecting to a remote server and making it possible in particular to recover and/or to process and/or to send digital data over the Internet. By way of example, the connection device may be hosted in a fixed or mobile terminal such as a personal computer, a tablet, or a smartphone, or in a gateway that may be a residential gateway or a business gateway. Said connection device is remarkable in that it possesses means for:
taking account of authentication data input by a user of said connection device for the purpose of authenticating said user with said remote server, said authentication data comprising at least a password;
applying a certain function to said authentication data input by the user;
comparing the result of applying said function to said authentication data input by the user with a previously stored result of applying the function to authentication data of that user with said remote server; and
in the event of a match, sending the user's identifier and password to the remote server; else
in the event of a mismatch, sending a message to the user requesting the user to verify that said authentication data input by the user is indeed the data the user wishes to send to the remote server, and proposing an interface to the user in order to enable the user to reply.

According to particular characteristics, said connection device also possesses means for acting, in the event of a mismatch, to:
take account of an indication by said user in said interface of the user's desire to correct the input;
take account of the new authentication data input by said user for authenticating the user with the remote server, said new authentication data comprising at least a password;
compare the result of said function applied to said new authentication data with said previously registered result; and
in the event of a match, send the user's identifier and password to the remote server.

According to other particular characteristics, said connection device also possesses means for acting, in the event of a mismatch, to:
take account of an indication from said user in said interface of the user's desire to update the authentication data;
register the result of applying said function to said authentication data input by the user, in association with an identifier of the remote server; and
send the user's identifier and password to the remote server.

According to yet other particular characteristics, said connection device also possesses means for acting, in the event of a mismatch, to:
take account of an indication from said user in said interface that the user is a new user;
register the result of applying said function to said authentication data input by the new user, in association with an identifier of the remote server; and
send the new user's identifier and password to the remote server.

According to yet other particular characteristics, the result of said function comprises at least a portion of said password of the user for said remote server, in the clear or in encrypted form.

In another aspect, the invention provides a web browser. Said web browser is remarkable in that it contains a connection device as set out briefly above.

The advantages made available by the connection device and by the web browser are essentially the same as the advantages made available by the corresponding methods set out briefly above.

It should be observed that it is possible to make the connection device and the web browser in the context of software instructions and/or in the context of electronic circuits.

The invention also provides a computer program downloadable from a communications network and/or stored on a computer readable medium and/or executable by a microprocessor. The computer program is remarkable in that it includes instructions for executing steps of the connection method for connecting to a remote server as set out briefly above, when executed on a computer.

The advantages made available by the computer program are essentially the same as those made available by said method.

Other aspects and advantages of the invention appear on reading the following detailed description of a particular implementation given by way of non-limiting example.

### BRIEF DESCRIPTION OF THE DRAWINGS

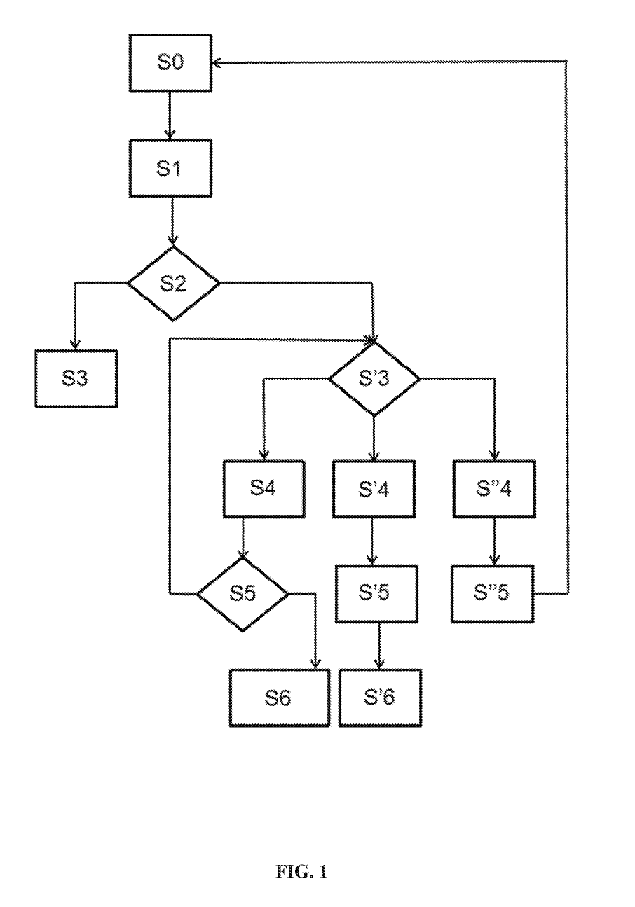

The description refers to the sole FIG. 1 that accompanies it, which is a flow chart of said implementation of the method of the invention for connecting to a remote server.

### DETAILED DESCRIPTION OF ILLUSTRATIVE EMBODIMENTS

There follows a description of the steps of this implementation. By way of example, it is assumed that the connection device of the invention is incorporated in a web browser hosted on a personal computer.

In an preliminary step S0, a user of the computer connects to a remote server making available a service desired by the user.

Optionally, before the connection, the browser verifies in known manner that the remote server is included in a white list (i.e. a list of servers deemed to be trustworthy); the person skilled in the art can provide various measures for use when the remote server is not included in said white list, e.g. displaying a message for warning the user that the server is not (or not yet) deemed to be trustworthy, and requesting the user to confirm the desire nevertheless to make a connection with that server (if confirmed, the server is put into the white list).

In accordance with the invention, the user's browser (or an appropriate module of the computer) applies a predetermined function to the data for enabling the user to be authenticated with the remote server. The result of this application comprises at least a portion of said password of the user for the remote server, either in the clear or in encrypted form. In the context of the two variants that are described below with reference to step S1, where the user inputs at least a portion of the user's identifier, said result also comprises at least a portion of the user's identifier for the remote server, either in the clear or in encrypted form.

In known manner, the encryption may be in the form of a hash, i.e. a non-invertible function of the authentication data.

The result is then stored in a dedicated memory (e.g. in the user's computer or in a cloud of an Internet operator), in association with an identifier of the remote server, e.g. its Internet protocol (IP) address.

In a step S1, during any subsequent access by that user to the same remote server, the user inputs the data for authenticating the user with that remote server. The authentication data comprises at least the user's password. In a first variant, the user also inputs the user's identifier in full. In a second variant (in known manner), the user inputs only a portion of the identifier, and then selects the full identifier from a list made available by the browser; this second variant is useful when several different people (each having their own identifier) are entitled to use that computer; specifically, in the absence of any indication on the part of the user, the browser cannot know which identifier is concerned for the present connection. Finally, in a third variant, the browser automatically provides the identifier of the user (assumed to be the sole user) of the computer for the remote server in question.

In a step S2, the user's browser (or an appropriate module of the computer) applies said function to the data input by the user during said step S1, and compares the result of this application with the result that was stored for that remote server during above-described step S0.

If there is a match, then in step S3, the browser sends the user's identifier and password to the remote server, and the session between the user and the remote server can begin. Optionally (still if there is a match), the browser verifies that the remote server is still in the white list before sending it the authentication data.

In contrast, if there is mismatch, then in a step S′3, the browser sends a message to the user asking whether the user is certain about sending the data that has just been input to the remote server; the user can thus verify whether there is a mistake in the authentication data as input. Furthermore, the browser makes an interface available to the user (e.g. by opening a window on the screen associated with the computer).

If, after receiving said message, the user realizes that there is a mistake, then, in a step S4, the user makes use of said interface to indicate a desire to correct the input; in a manner analogous to above step S1 the user then inputs the data for authenticating the user with the remote server once more, either into said interface or into the initial input field, said data comprising at least the password.

In a step S5, in a manner analogous with above step S2, the user's browser (or an appropriate module of the computer) applies said function to the data input by the user during said step S4, and compares the result of that application with the result that was stored for that remote server during the step S0.

If the user has again made a mistake, the method returns to above step S′3.

If there is match with the stored result, then in step S6 analogous to above step S3, the browser sends the user's identifier and password to the remote server (optionally after verifying that the remote server is still in the white list), and the session can then begin.

In contrast, after said step S′3, the user may see that the data input in step S1 is indeed the data for enabling the user to be authenticated with the remote server. Specifically, this situation can arise if, during a preceding session with the remote server, the user changed the identifier and/or the password with that server, so that the result of applying the function to the authentication data that was stored during the preliminary step S0 is obsolete.

Under such circumstances, in a step S′4, the user uses said interface to indicate a desire to update the user's authentication data.

In a step S′5, either the user inputs the authentication data again into said interface or into the initial input field, or else the browser recovers the authentication data input during step S1; the result of applying said function to said authentication data is then stored in said dedicated memory.

Finally, in a step S′6, the browser sends the user's identifier and password to the remote server (optionally after verifying that the remote server is still in a white list), and the session can begin.

Naturally, the order of said steps S′5 and S′6 can be reversed.

After said step S′3, another possible situation is that in which a new user seeks to register with a connection device of the invention with which at least one user has already been registered.

Under such circumstances, in a step S″4, the new user uses said interface to declare that he or she is a new user.

In a step S″5, either the new user inputs the authentication data again in said interface or in the initial input field, or else the browser recovers the authentication data as input during step S1.

This thus returns to the situation of the preliminary step S0, but with the new user. Thus:
the result of applying said function to the authentication data for the new user is stored in said dedicated memory; and
the user sends the new user's identifier and password to the remote server (optionally after verifying that the remote server is still in a white list).

The session can then begin.

Naturally, the order of said steps of registration and of sending to the remote server may be reversed.

The invention may be implemented in nodes of communication networks, e.g. computers, terminals, or gateways, by means of software and/or hardware components.

The software components may be integrated in a conventional computer program for managing a network node. That is why, as mentioned above, the present invention also provides a computer system. The computer system includes in conventional manner a central processor unit using signals to control a memory and an input unit and an output unit. In addition, the computer system can be used to execute a computer program including instructions for performing any of the methods of the invention for making a connection to a remote server.

Specifically, the invention also provides a computer program that is downloadable from a communications network and that includes instructions for executing steps of a method of the invention for making a connection to a remote server when it is executed on a computer. The computer program may be stored on a computer-readable medium and may be executable by a microprocessor.

The program may also use any programming language and be in the form of source code, object code, or code intermediate between source code and object code, such as in a partially compiled form or in any other desirable form.

The invention also provides a non-removable, or partially or completely removable data medium that is readable by a computer and that includes instructions of a computer program as mentioned above.

The data medium may be any entity or device capable of storing the program. For example, the medium may comprise storage means, such as a read only memory (ROM), e.g. a compact disk (CD) ROM, or a microelectronic circuit ROM, or magnetic recording means, such as a hard disk, or indeed a universal serial bus (USB) flash drive.

Furthermore, the data medium may be a transmissible medium such as an electrical or optical signal, which may be conveyed via an electrical or optical cable, by radio, or by other means. The computer program of the invention may in particular be downloaded from an Internet type network.

In a variant, the data medium may be an integrated circuit in which the program is incorporated, the circuit being adapted to execute or to be used in the execution of any of the methods of the invention for connecting with a remote server.

Although the present disclosure has been described with reference to one or more examples, workers skilled in the art will recognize that changes may be made in form and detail without departing from the scope of the disclosure and/or the appended claims.

1. A connection method for connecting to a remote server, the method comprising:
a preliminary step during which, on a user accessing said remote server by using a connection device, said user registers in said connection device, in association with an identifier of the remote server, a result of applying a certain function to authentication data of the user with the remote server; and
on subsequent access of the user to the remote server by using the connection device, the following steps:
a) the user inputting authentication data for authenticating the user with the remote server, said authentication data comprising at least a password;
b) the connection device comparing the result of said function applied to said authentication data input during said step a) with said result stored during said preliminary step; and
c1) in the event of a match, the connection device sending the user's identifier and password to the remote server; and
c2) in the event of a mismatch, the connection device proposing an interface to the user in order to enable the user to confirm or to invalidate the authentication data input during step a).

2. The connection method for connecting to a remote server according to claim 1, wherein if, after receiving said proposal of an interface, the user realizes that said authentication data input during said step a) is erroneous, said method further comprises the following steps:
d) said user using said interface to indicate the desire to correct the input, and the user inputting new authentication data for authenticating the user with the remote server, said new authentication data comprising at least a password;
e) comparing the result of said function applied to said new authentication data with said result stored during said preliminary step; and
f) in the event of a match, sending the user's identifier and password inputted in step d) to the remote server.

3. The connection method for connecting to a remote server according to claim 1, wherein if, after receiving said proposal of an interface, the user realizes that said result stored during said preliminary step is obsolete, said method further comprises the following steps:
d′) said user using said interface to indicate (S′4) the desire to update the user's authentication data;
e′) registering (S′5) the result of applying said function to said authentication data input by the user during said step a), in association with an identifier of the remote server; and
f′) sending (S′6) the user's identifier and password to the remote server.

4. The connection method for connecting to a remote server according to claim 1, characterized in that, after receiving said proposal of an interface, said method further comprises the following steps:
d″) said user using said interface to indicate that the user is a new user;
e″) registering the result of applying said function to said authentication data input by the new user during said step a), in association with the identifier of the remote server; and
f″) sending the new user's identifier and password to the remote server.

5. The connection method for connecting to a remote server according to claim 1, wherein the result of said function comprises at least a portion of said password of the user for said remote server, in the clear or in encrypted form.

6. A connection device for connecting to a remote server, the device comprising:
a processor; and
a non-transitory computer-readable medium comprising instructions stored thereon, which when executed by the processor configure the connection device to perform acts comprising:
taking account of authentication data input by a user of said connection device for the purpose of authenticating said user with said remote server, said authentication data comprising at least a password;
applying a certain function to said authentication data input by the user;
comparing a result of applying said function to said authentication data input by the user with a previously stored result of applying the function to authentication data of that user with said remote server; and
in the event of a match, sending the user's identifier and password to the remote server; else
in the event of a mismatch, proposing an interface to the user in order to enable the user to confirm or to invalidate said authentication data input by the user.

7. The connection device according to claim 6, wherein the instructions further configure the connection device, in the event of a mismatch, to:
take account of an indication by said user in said interface of the user's desire to correct the input;
take account of the new authentication data input by said user for authenticating the user with the remote server, said new authentication data comprising at least a password;
compare the result of said function applied to said new authentication data with said previously registered result; and
in the event of a match, send the user's identifier and password comprised in the new authentication data to the remote server.

8. The connection device according to claim 6, wherein the instructions further configure the connection device, in the event of a mismatch, to:
take account of an indication from said user in said interface of the user's desire to update the authentication data;
register the result of applying said function to said authentication data input by the user, in association with an identifier of the remote server; and
send the user's identifier and password to the remote server.

9. The connection device according to claim 6, wherein the instructions further configure the connection device, in the event of a mismatch, to:
take account of an indication from said user in said interface that the user is a new user;
register the result of applying said function to said authentication data input by the new user, in association with an identifier of the remote server; and
send the new user's identifier and password to the remote server.

10. The connection device according to claim 6, wherein the result of said function comprises at least a portion of said password of the user for said remote server, in the clear or in encrypted form.

11. The connection device according to claim 6, which is implemented as part of a web browser.

12. A non-transitory computer-readable data storage medium comprising computer program code instructions stored thereon for executing steps of a connection method for connecting to a remote server when the instructions are executed by a processor of a connection device, wherein the instructions configure the connection device to perform acts comprising:
a preliminary step during which, on a user accessing said remote server by using the connection device, said user registers in said connection device, in association with an identifier of the remote server, a result of applying a certain function to authentication data of the user with the remote server; and
on subsequent access of the user to the remote server by using the connection device, the following steps:
a) the user inputting authentication data for authenticating the user with the remote server, said authentication data comprising at least a password;
b) the connection device comparing the result of said function applied to said authentication data input during said step a) with said result stored during said preliminary step; and
c1) in the event of a match, the connection device sending the user's identifier and password to the remote server; and
c2) in the event of a mismatch, the connection device proposing an interface to the user in order to enable the user to confirm or to invalidate the authentication data input during step a).

13. (canceled)

14. The connection method according to claim 1, wherein, along with said step of proposing an interface to the user, the connection device sends a message to the user asking the user to verify that the authentication data input during step a) is indeed the data the user wishes to send to the remote server.

15. The connection device according to claim 6, wherein the instructions further configure the connection device to send a message to the user asking the user to verify that said authentication data input by the user is indeed the data the user wishes to send to the remote server.

16. The computer-readable data storage medium according to claim 12, wherein said instructions further configure the connection device to send a message to the user asking the user to verify that said authentication data input by the user is indeed the data the user wishes to send to the remote server.
